(19) United States
(12) Patent Application Publication
(10) Pub. No.: US 2024/0242131 A1
(43) Pub. Date: Jul. 18, 2024

(54) SYSTEM AND METHOD FOR DATA CLASSIFICATION

(71) Applicants: INDIAN INSTITUTE OF TECHNOLOGY MADRAS (IIT MADRAS), Chennai, Tamil Nadu (IN); CLARITRICS INC D.B.A BUDDI HEALTH (US/US), New York, NY (US)

(72) Inventors: Balaraman RAVINDRAN, Chennai, Tamil Nadu (IN); Sudarsun SANTHIAPPAN, Chennai, Tamil Nadu (IN); Nitin SHRAVAN, Coimbatore, Tamil Nadu (IN)

(21) Appl. No.: 18/557,684

(22) PCT Filed: Apr. 20, 2022
(86) PCT No.: PCT/IN2022/050376

§ 371 Date: Oct. 27, 2023

(30) Foreign Application Priority Data
Apr. 30, 2021 (IN) 202141019838

(51) Int. Cl. G06N 20/20

(52) U.S. Cl. CPC G06N 20/20

(57) ABSTRACT

The present disclosure describes a method and system (120) for data classification. The system (120) comprises at least one processor (230) coupled to memory (240) and configured to receive at least one first dataset comprising at least one labeled dataset and at least one unlabeled dataset and process the received labeled dataset to generate at least one first meta feature comprising cluster indices. The processor (230) is further configured to estimate a classification performance score of each of a plurality of classification models for the at least one labeled dataset by correlating the generated meta features with a prebuilt model. The processor (230) is further configured to generate a list comprising the classification models arranged in descending order of the estimated performance scores and select a top N classification models from the list to build an ensemble classification model for classifying the at least one unlabeled dataset.

### TECHNICAL FIELD

The present disclosure generally relates to the field of automated machine learning. Particularly, the present disclosure relates to a system and a method for data classification.

### BACKGROUND

Machine learning is an important and fast growing field in computer science. It is helpful in addressing various real-world problems. Machine learning uses various concepts from statistics to build models that can learn patterns from historical data to predict new output values. Due to its applications over a wide variety of fields, machine learning has seen immanence growth in both academics and industries.

In the field of supervised machine learning, classification refers to a predictive modeling problem where a class label is predicted for a given data. Classification draws some conclusions from input data given for training and predicts class labels/categories for the given data. Classifying the given data is a very important task in machine learning, for example, whether an email is spam email or non-spam email, whether a transaction is fraudulent or not, and like. Due to the vast applications of classification, it becomes necessary to select a best classification model for a given dataset.

The performance of any machine learning classification task depends on choice of the learning model, choice of classification model, and dataset's characteristics. Various classification models/methods have been introduced for data classification. Classification model selection is a process of identifying a suitable classification model that is most appropriate for classifying a given dataset. The selection of a suitable classification model that maximizes performance for a given task is an essential step in data science. The traditional approach for selecting a best classification model is to train different classification models, evaluate their performance on a validation set, and choose a best classification model. However, this approach is time-consuming and resource-intensive and requires user intervention for selecting the best classification model.

Nowadays, various techniques for automated classification model selection have been introduced such as meta-learning, deep reinforcement learning, Bayesian optimization, evolutionary algorithms, and budget-based evaluation. These techniques automatically select a classification model for a given dataset. However, these automated classification model techniques are also time consuming and resource intensive. Moreover, due to technological advancements in recent times, the amount of data generated is continuously increasing. However, accurate classification of a huge dataset in real time is difficult using the conventional techniques.

Thus, with the huge and rapidly growing amount of data that needs to be classified, there exists a need for further improvements in the technology, especially for time and resource efficient techniques that can automatically select best classification models for a given dataset and that can accurately classify the given dataset in real time even if the dataset comprises huge amount of data.

Conventionally, there are no techniques available in the market that can address the above-identified problems. Hence, there exists a need for the technology that facilitates time and resource efficient automated classification model selection for accurately classifying a given dataset.

The information disclosed in this background section is only for enhancement of understanding of the general background of the invention and should not be taken as an acknowledgement or any form of suggestion that this information forms the prior art already known to a person skilled in the art.

### SUMMARY

One or more shortcomings discussed above are overcome, and additional advantages are provided by the present disclosure. Additional features and advantages are realized through the techniques of the present disclosure. Other embodiments and aspects of the disclosure are described in detail herein and are considered a part of the disclosure.

An objective of the present disclosure is to automatically recommend/select one or more best classification models.

Another object of the present disclosure is to classify a given dataset using the one or more best classification models.

Another objective of the present disclosure is to accurately assign class labels to unlabeled datasets in a time and resource efficient manner.

Another objective of the present disclosure is to determine classification complexity of a given dataset.

Yet another objective of the present disclosure is to provide machine learning as a service platform for classification model building and data classification.

The above stated objects as well as other objects, features, and advantages of the present disclosure will become clear to those skilled in the art upon review of the following description, the attached drawings, and the appended claims.

According to an aspect of the present disclosure, methods and systems are provided for data classification.

In a non-limiting embodiment of the present disclosure, the present application discloses a method for data classification. The method may comprise receiving at least one first dataset, where the at least one first dataset may comprise at least one labeled dataset and at least one unlabeled dataset. The method may further comprise processing the at least one labeled dataset to generate at least one first meta feature from the at least one labeled dataset, where the at least one first meta feature is at least one first cluster index. The method may further comprise correlating the at least one first meta feature with a prebuilt model comprising a plurality of classification models, where the prebuilt model further comprises at least one mapping function for mapping at least one pre-calculated meta feature with a plurality of pre-calculated classification performance scores corresponding to the plurality of classification models. The method may further comprise estimating a classification performance score of each of the plurality of classification models for the at least one labeled dataset, based on correlating the at least one first meta feature with the prebuilt model. The method may further comprise generating a list comprising the plurality of classification models arranged in descending order of the estimated classification performance scores and selecting a predefined number of top classification models from the list to build an ensemble classification model for classifying the at least one unlabeled dataset.

In another non-limiting embodiment of the present disclosure, the classifying the at least one unlabeled dataset may comprises processing the at least one unlabeled dataset using the ensemble classification model to predict class labels based on one of: majority voting, weighted averaging, and model stacking.

In another non-limiting embodiment of the present disclosure, the processing the at least one labeled dataset to generate at least one first meta feature may comprises processing the at least one labeled dataset to generate at least one cleaned dataset; processing the at least one cleaned dataset using at least one clustering model to generate one or more clusters; and generating a multi-dimensional vector by processing the one or more clusters, the multi-dimensional vector comprising the at least one first meta feature.

In another non-limiting embodiment of the present disclosure, the method may further comprise determining a classification complexity of the at least one first dataset by comparing the estimated classification performance scores with a preset threshold value.

In another non-limiting embodiment of the present disclosure, the prebuilt model may be generated by: receiving at least one second dataset; processing the at least one second dataset to generate at least one training sub-dataset; processing the at least one training sub-dataset using at least one clustering model to generate one or more clusters; generating a multi-dimensional vector by processing the one or more clusters, where the multi-dimensional vector comprises at least one second meta feature corresponding to the at least one training sub-dataset, and where the at least one second meta feature is at least one second cluster index; generating a plurality of classification performance scores corresponding to the plurality of classification models by processing the at least one training sub-dataset; and generating the prebuilt model by correlating the generated at least one second meta feature with the generated plurality of classification performance scores, where the at least one second meta feature corresponds to the at least one pre-calculated meta feature, and wherein the plurality of classification performance scores corresponds to the plurality of pre-calculated classification performance scores.

In another non-limiting embodiment of the present disclosure, generating a plurality of classification performance scores corresponding to the plurality of classification models may comprise generating a best classification performance score for each of the plurality of classification models by tuning one or more hyper parameters corresponding to the plurality of classification models

In another non-limiting embodiment of the present disclosure, the present application discloses a system for data classification. The system may comprise a memory and at least one processor communicatively coupled with the memory. The at least one processor may be configured to receive at least one first dataset that comprises at least one labeled dataset and at least one unlabeled dataset. The at least one processor may be further configured to process the at least one labeled dataset to generate at least one first meta feature from the at least one labeled dataset, where the at least one first meta feature is at least first one cluster index. The at least one processor may be further configured to correlate the at least one first meta feature with a prebuilt model comprising a plurality of classification models. The prebuilt model may further comprise at least one mapping function for mapping at least one pre-calculated meta feature with a plurality of pre-calculated classification performance scores corresponding to the plurality of classification models. The at least one processor may be further configured to estimate a classification performance score of each of the plurality of classification models for the at least one labeled dataset, based on correlating the at least one first meta feature with the prebuilt model and generate a list comprising the plurality of classification models arranged in descending order of the estimated classification performance scores. The at least one processor may be further configured to select a predefined number of top classification models from the list to build an ensemble classification model for classifying the at least one unlabeled dataset.

In another non-limiting embodiment of the present disclosure, the at least one processor may be configured to classify the at least one unlabeled dataset by processing the at least one unlabeled dataset using the ensemble classification model to predict class labels based on one of: majority voting, weighted averaging, and model stacking.

In another non-limiting embodiment of the present disclosure, the at least one processor may be configured to process the at least one labeled dataset to generate at least one first meta feature by: processing the at least one labeled dataset to generate at least one cleaned dataset; processing the at least one cleaned dataset using at least one clustering model to generate one or more clusters; and generating a multi-dimensional vector by processing the one or more clusters, the multi-dimensional vector comprising the at least one first meta feature.

In another non-limiting embodiment of the present disclosure, the at least one processor may be further configured to determine a classification complexity of the at least one first dataset by comparing the estimated classification performance scores with a preset threshold value.

In another non-limiting embodiment of the present disclosure, the at least one processor may be further configured to generate the prebuilt model by receiving at least one second dataset; processing the at least one second dataset to generate at least one training sub-dataset; and processing the at least one training sub-dataset using at least one clustering model to generate one or more clusters. The at least one processor may be further configured to generate a multi-dimensional vector by processing the one or more clusters, where the multi-dimensional vector comprises at least one second meta feature corresponding to the at least one training sub-dataset, and where the at least one second meta feature is at least one second cluster index. The at least one processor may be further configured to generate a plurality of classification performance scores corresponding to the plurality of classification models by processing the at least one training sub-dataset. The at least one processor may be further configured to generate the prebuilt model by correlating the generated at least one second meta feature with the generated plurality of classification performance scores, where the at least one second meta feature corresponds to the at least one pre-calculated meta feature, and where the plurality of classification performance scores corresponds to the plurality of pre-calculated classification performance scores.

In another non-limiting embodiment of the present disclosure, the at least one processor may be configured to generate a plurality of classification performance scores corresponding to the plurality of classification models by generating a best classification performance score for each of the plurality of classification models by tuning one or more hyper parameters corresponding to the plurality of classification models.

In another non-limiting embodiment of the present disclosure, the system may be configured to provide a Machine Learning as a service (MLaaS) platform for data classification and classification model selection.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Further aspects and advantages of the present disclosure will be readily understood from the following detailed description with reference to the accompanying drawings. Reference numerals have been used to refer to identical or functionally similar elements. The figures together with a detailed description below, are incorporated in and form part of the specification, and serve to further illustrate the embodiments and explain various principles and advantages, in accordance with the present disclosure wherein:

FIG. 1 shows an exemplary environment of a communication system 100 for data classification, in accordance with some embodiments of the present disclosure;

FIG. 2 shows a block diagram 200 of the communication system 100 illustrated in FIG. 1, in accordance with some embodiments of the present disclosure;

FIG. 3 shows a process flow diagram 300 for model selection and data classification, in accordance with some embodiments of the present disclosure.

FIG. 4 shows a block diagram 400 of a computing system 110, 120, in accordance with some embodiments of the present disclosure.

FIG. 5 depicts a flowchart 500 illustrating a method for data classification, in accordance with some embodiments of the present disclosure.

FIG. 6 depicts a flowchart 600 illustrating a method for generating a trained/prebuilt model, in accordance with some embodiments of the present disclosure.

It should be appreciated by those skilled in the art that any block diagrams herein represent conceptual views of the illustrative systems embodying the principles of the present disclosure. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present disclosure described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however, that it is not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus proceeded by “comprises . . . a” does not, without more constraints, preclude the existence of other elements or additional elements in the system.

The terms like “at least one” and “one or more” may be used interchangeably throughout the description. The terms like “a plurality of” and “multiple” may be used interchangeably throughout the description. Further, the terms like “mapping function”, “regressor”, and “regression function” may be used interchangeably throughout the description. Further, the terms like “prebuilt model” and “trained model” may be used interchangeably throughout the description.

In the following detailed description of the embodiments of the disclosure, reference is made to the accompanying drawings that form a part hereof, and in which are shown by way of illustration of specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

In general, clustering is an unsupervised machine learning task and classification is a supervised machine learning task. In the present disclosure, clustering indices represent cluster evaluation metrics used to assess quality of clusters induced by a clustering model for a given dataset. Clustering models group datasets having similar characteristics into neighborhoods or disjuncts of different sizes. Clustering indices measure the ability of a clustering model to induce good quality neighborhoods that share similar data characteristics. Thus, the clustering indices represent the dataset characteristics with respect to a clustering model. In the present disclosure, clustering indices are used as meta-features for classification model selection and for accurately classifying a given dataset.

In the present disclosure, the term model-fitness denotes the ability of a classification model to learn a classification task on a given dataset. The actual model-fitness of a dataset may be measured based on the expected classification performance of a classification model on a given dataset. F1 score is used as the classification performance metric in the present disclosure.

In the present disclosure, the term classification-complexity indicates the difficulty of learning a classification model on a given dataset.

In machine learning, classification task is a discriminant function that maps characteristics of datasets to an appropriate output category. In general, a discriminant function is a function of several variates used to assign items into one of two or more groups. A machine learning classification model is dictated by the ability to generalize and classify unobserved data.

The present disclosure provides techniques (methods and systems) for data classification and model selection. As described in background section, the conventional technique for classification model selection are time consuming and resource intensive and it is difficult to perform accurate classification of a huge dataset in real time using the conventional techniques.

To overcome these and other problems, the present disclosure proposes techniques that use clustering indices for automatically selecting one or more classification models from a plurality of available classification models to form an ensemble classification model. The ensemble classification model may be used for accurately classifying a given dataset. The present disclosure uses clustering indices as data characteristics (or meta features) for selecting best classification models to build the ensemble classification model without fitting/training the plurality of classification models over the dataset. The disclosure may provide machine learning as a service (MLaaS) platform to users for data classification and classification model selection.

Nowadays, the demand for machine learning as a service has been increasing with the growing amount of data sources. Companies across industries are harnessing the power of machine learning at various stages in their product cycle. This has paved the way for companies to provide machine learning as a service. A functional and ready-to-use Machine Learning as a Service (MLaaS) platform is beneficial for small companies, developers and researchers and helps them in building their own solutions. It helps overcome the need for high computational resources and time spent. The proposed system of the present disclosure can be availed as a service for machine learning model building. Particularly, the ensemble classification model may be offered to users/clients either as a prediction Application Programming Interface (API) or deployable solution.

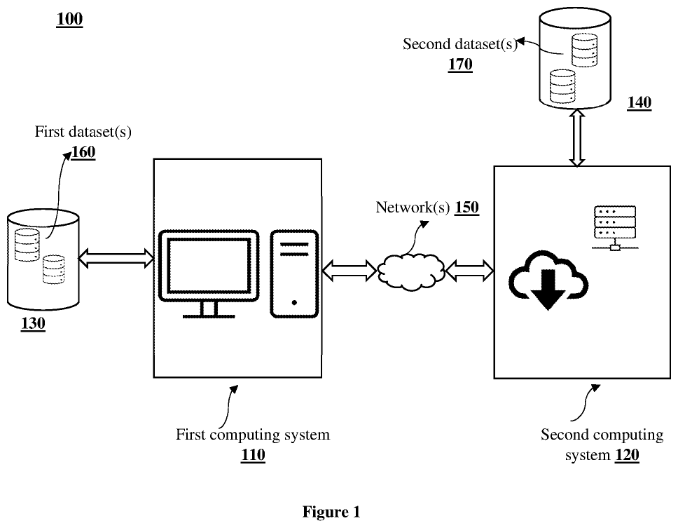

Referring now to FIG. 1, which illustrates a communication system 100 for use in data classification and model(s) selection, in accordance with some embodiments of the present disclosure. The communication system 100 may comprise a first computing system 110 (or client computing system) which may be in communication with one or more first data sources 130. The one or more first data sources 130 may comprise at least one first dataset 160 whose classification is to be performed. The communication system 100 may further comprise a second computing system 120 (or a server) in communication with the first computing system 110 via at least one network 150. Additionally, the second computing system 120 may be in communication with one or more second data sources 140. The one or more second data sources 140 may comprise at least one second dataset 160 for training the second computing system 120.

The network 150 may comprise a data network such as, but not restricted to, the Internet, Local Area Network (LAN), Wide Area Network (WAN), Metropolitan Area Network (MAN), etc. In certain embodiments, the network 150 may include a wireless network, such as, but not restricted to, a cellular network and may employ various technologies including Enhanced Data rates for Global Evolution (EDGE), General Packet Radio Service (GPRS), Global System for Mobile Communications (GSM), Internet protocol Multimedia Subsystem (IMS), Universal Mobile Telecommunications System (UMTS) etc. In one embodiment, the network 150 may include or otherwise cover networks or subnetworks, each of which may include, for example, a wired or wireless data pathway.

The first and second data sources 130, 140 may be any data source comprising huge volumes of data and/or information. The first and second data sources 130, 140 may be any public or private data sources such as, but not limited to, banking records, IoT logs, computerized medical records, online shopping records, chat data of users stored on servers, even logs of computing devices, vulnerability databases etc. The first computing system 110 may fetch/receive the at least one first dataset 160 from the at least one first data source 130 and the second computing system 110 may fetch/receive the at least one second dataset 170 from the at least one second data source 140.

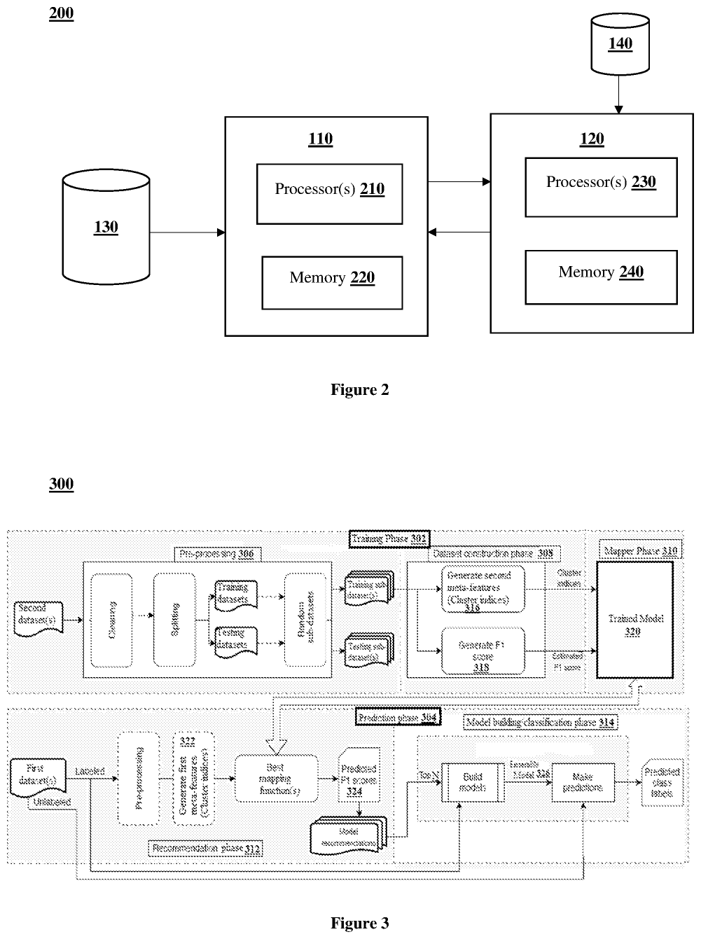

Now, FIG. 1 is explained in conjunction with FIG. 2, which is a block diagram 200 of the communication system 100, in accordance with some embodiments of the present disclosure. According to an embodiment of the present disclosure, the communication system 100, 200 may comprise the first computing system 110, the second computing system 120, the at least one first source 130, and the at least one second source 140. The first computing system 110 may comprise at least one first processor 210 and at least one first memory 220. Similarly, the second computing system 120 may comprise at least one second processor 230 and at least one second memory 240.

The first and second processors 210, 230 may include, but not restricted to, a general-purpose processor, a Field Programmable Gate Array (FPGA), an Application Specific Integrated Circuit (ASIC), a Digital Signal Processor (DSP), microprocessors, microcomputers, micro-controllers, central processing units, state machines, logic circuitries, and/or any devices that manipulate signals based on operational instructions. A processor may also be implemented as a combination of computing devices, e.g., a combination of a DSP and a microprocessor, a plurality of microprocessors, one or more microprocessors in conjunction with a DSP core, or any other such configuration.

The first memory 220 may be communicatively coupled to the at least one first processor 210 and the second memory 240 may be communicatively coupled to the at least one second processor 230 The first and second memory 220, 240 may comprise various instructions, one or more datasets, and one or more clusters, one or more class labels, one or more classification models, one or more clustering models etc. The first and second memory 220, 240 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth.

The communication system 100 proposed in present disclosure may be named as a data classification system which may build a trained model, select at least one classification model using the trained model, form an ensemble classification model using the selected at least one classification model, and classify a given dataset using the ensembled classification model.

In one non-limiting embodiment of the present disclosure, the at least one first processor 210 may extract the at least one first dataset 160 from the at least one first data source 130. In one non-limiting embodiment, the one or more datasets 160 may be transmitted to the first processor 210. The at least one first processor 210 may transmit the at least one first dataset 160 to the second at least one second processor 230 of the second computing system 120. The at least one second processor 230 may process the received at least one first dataset 160 to assign one or more class labels. The at least one second processor 230 uses a pre-built/trained model for data classification. The processing at the at least one second processor 230 is described below with the help of a process flow diagram 300 as described in FIG. 3.

The second computing system 120 may work in two phases: first phase being a training phase 302 and a second phase being a prediction phase 304. It may be worth noting here that the second computing system 120 is first trained, and the model selection and data classification is done thereafter. The outcome of the training phase 302 is a trained model or a pre-built model 320. The terms ‘trained model’ and ‘pre-built model’ are used interchangeably throughout the description.

The training phase 302 may further be divided into three sub-phases: preprocessing phase 306, dataset construction phase 308, and mapper phase 310. The prediction phase 304 may be further divided into two sub-phases: recommendation phase 312 and model building/classification phase 314. The recommendation phase 312 may comprise some or all functionalities of the preprocessing phase 306 and the dataset construction phase 308 of the training phase 302. Different phases are now explained below in details.

### Training Phase:

In one non-limiting embodiment of the present disclosure, the at least one second processor 230 may receive or fetch at least one second dataset 170 from the at least one second data source 140. The at least one second dataset 170 may be collectively represented as DT and may comprise one or more datasets:

$${D}_{T} = \{ {D}_{1} , {D}_{2} , {D}_{3} , … , {D}_{n} \} \qquad ( 1 )$$

In one non-limiting embodiment of the present disclosure, the preprocessing phase 306 may comprise several sub-tasks to transform the at least one second dataset 170 into a set BT of several sub-datasets (or sub-samples) generated by stratified random sampling with replacement. In one sub-task, the at least one second processor 230 may perform cleaning operation on the received at least one second dataset 170 to generate at least one cleaned dataset. Data cleaning identifies and removes errors and duplicate data from the at least one second dataset 170 in order to create a reliable dataset. Data cleaning improves quality of training data and enables accurate decision making. Cleaning of the at least one second dataset 170 may comprise, but not limited to, normalizing the at least one second dataset 170, dropping empty cells from the at least one second dataset 170, and standardizing the at least one second dataset 170, and like. The purpose of cleaning is to remove unwanted data from the at least one second dataset 170 in order to make the dataset uniform and understandable for various machine learning models. Cleaning the at least one second dataset 170 at the initial stage may reduce unnecessary computations at subsequent stages thereby saving overall time of the training phase 302.

In one non-limiting embodiment of the present disclosure, the at least one second processor 230 may divide the cleaned dataset in a pre-defined ratio of training and testing datasets. In one non-limiting embodiment, the pre-defined ratio may be 70:30 or 80:20. The training datasets may be used for training the computing system 120 to generate the trained model 320 and the testing datasets may be used for cross-validating the trained model 320. The testing datasets may be referred as validation datasets.

In one non-limiting embodiment of the present disclosure, the training and testing datasets may undergo independent sampling in order to generate respective sub-datasets i.e., at least one training sub-datasets may be generated from training datasets and at least one testing sub-datasets may be generated from testing datasets. The sampling used here is stratified random sampling with replacement. It may be noted here that sampling (i.e., construction of multiple sub-datasets) results in an increased number of datasets to train the prebuilt model 320 and higher the number of training datasets, better is the model generated and higher is the accuracy. Another advantage of using sub-datasets is to provide broader coverage of dataset variance characteristic to regression functions. The set of training sub-datasets may be represented as BT:

$${B}_{T} = \{ {B}_{1} , {B}_{2} , {B}_{3} , … , {B}_{n} \} \qquad ( 2 )$$

The testing sub-datasets may be a part of set BT or may be a separate set. The output of the preprocessing phase 306 is the sub-datasets which are fed as input to dataset construction phase 308.

In one non-limiting embodiment of the present disclosure, the at least one second processor 230 in the dataset construction phase 308 may receive the generated training and testing sub-datasets and may process them to generate one or more multi-dimensional vectors. The processing at the dataset construction phase 308 happens in two parallel steps 316 and 318. In one non-limiting embodiment of present disclosure, at least one clustering model and a plurality of classification models may be pre-defined/pre-fed to the at least one second processor 230. The at least one clustering model may be collectively represented as A, and the plurality of classification models may be collectively represented as C, where

$$A = \{ {A}_{1} , {A}_{2} , {A}_{3} , … , {A}_{n} \} \qquad ( 3 )$$

$$C = \{ {C}_{1} , {C}_{2} , {C}_{3} , … , {C}_{n} \} \qquad ( 4 )$$

In a first step 316 of the dataset construction phase 308, the at least one second processor 230 may process the at least one training sub-datasets using the at least one clustering model A to generate at least one cluster for each clustering model. Clusters generated using the at least one clustering model may be collectively represented as a multi-dimensional vector CL which may comprise different clusters generated by the different clustering models.

$$CL = \{ {CL}_{1} , {CL}_{2} , {CL}_{3} , … , {CL}_{n} \} \qquad ( 5 )$$

where CLᵢ denotes the set of clusters generated by a clustering model Cᵢ. Each of the set of cluster may further comprise at least one cluster as follows:
Clusters generated by model A₁: CL₁={CL₁₁, CL₁₂, CL₁₃, . . . , CL₁ₙ}
Clusters generated by model A₂: CL₂={CL₂₁, CL₂₂, CL₂₃, . . . , CL₂ₙ}
Clusters generated by model A₃: CL₃={CL₃₁, CL₃₂, CL₃₃, . . . , CL₃ₙ}
Clusters generated by model Am: CLₘ={CLₘ₁, CLₘ₂, CLₘ₃, . . . , CLₘₙ}

After generating at least one cluster for each clustering model, the at least one second processor 230 may process each of the generated cluster to extract meta-features from each of the generated cluster. The meta-features, also called as data characteristics, are able to characterize the complexity of datasets and to provide estimates of performance of different clustering models. In the present disclosure, clustering indices are used as the meta-features that represent different characteristics of the at least one second dataset DT. It may be worth noting here that the clustering indices have a strong correlation with the performance of a classification/clustering model for a given dataset. Different clustering models have different clustering assumptions for grouping the sub-datasets into neighborhoods. When the clustering indices measure the performance of such clustering algorithms, they inherently capture different properties of the sub-datasets. In general, clustering indices are measures for validating the clusters induced by a clustering model.

The clustering indices may be divided into two categories: internal clustering indices and external clustering indices. When a clustering index is independent of any external information such as data labels, the index is called an internal clustering index or quality index. On the contrary, when a clustering index uses data point labels, it is called an external clustering index. Thus, external clustering indices require a priori data for the purposes of evaluating the results of a clustering model, whereas internal clustering indices do not. Some of the most commonly used clustering indices are as follows:

Internal clustering indices: Dispersion, Banfeld-Raftery, Ball-Hall, PBM, Det-Ratio, Log-Det-Ratio, Ksq-DetW, Score, Silhoutte, Log-SS-Ratio, C-index, Dunn, Ray-Turi, Calinski-Harabasz, Trace-WiB, Davies-Bouldin etc.

External clustering indices: Entropy, Purity, Recall, Folkes-Mallows, Rogers-Tanimoto, F1, Kulczynski, Norm-Mutual-Info, Sokal-Sneath, Rand, Hubert, Homogenity, Completeness, V-Measure, Jaccard, Adj-Rand, Phi, McNemar, Russel-Rao, Precision etc.

At least one desired clustering index may be pre-selected and fed to the at least one second processor 230. The at least one second processor 230 may then determine values of the at least one desired clustering index for the generated clusters of each clustering model. The values of clustering indices may be determined using conventional known techniques. The at least one second processor 230 may then determine the final clustering indices for the particular clustering model by taking average of corresponding clustering indices of different clusters of the particular clustering model to generate a multidimensional vector of the clustering indices. The multidimensional vector of the clustering indices may be represented as IT. Now the generation of multidimensional vector IT is explained by way of an example.

Consider an example, where two clustering algorithms A₁ and A₂ are used for clustering the sub-datasets and there are two clusters generated by each of the clustering models A₁, A₂.
Clustering models A={A₁, A₂}
Clusters for first clustering model A₁: CL₁={CL₁₁, CL₁₂}
Clusters for second clustering model A₂: CL₂={CL₂₁, CL₂₂} Consider that two clustering indices I₁ and I₂ are used as meta-features. The at least one second processor 230 may determine value of I₁ and I₂ for each of the generated clusters.
Values of first clustering index I₁ for CL₁₁=I₁₁₁
Values of first clustering index I₁ for CL₁₂=I₁₁₂
Values of second clustering index 12 for CL₁₁=I₂₁₁
Values of second clustering index I₂ for CL I₂=I₂₁₂

The at least one second processor 230 may then determine the value of the first clustering index I₁ for the first clustering model A₁ by taking average of the values I₁₁₁, I₁₁₂ of first clustering index I₁ generated for different clusters CL₁₁, CL₁₂ of the first clustering model A₁.

i.e., value of first clustering index I₁ for the first clustering model A₁:

$${I}_{11} = avg ( {I}_{111} , {I}_{112} )$$

similarly,

value of second clustering index I₂ for the first clustering model A₁:

$${I}_{21} = avg ( {I}_{211} , {I}_{212} )$$

Now, the values of clustering indices I₁ and I₂ for the first clustering model A₁ have been determined. In the similar manner, the at least one second processor 230 may determine the values of the clustering indices I₁ and I₂ for the second clustering model A₂ (i.e., I₁₂ and I₂₂) The values of the clustering indices for the two clustering models A₁ and A₂ may then be concatenated to form the multidimensional vector of the clustering indices I_{T}.

$${I}_{T} = ( {\underbrace{\{ {I}_{11} , {I}_{21} \} ,}}_{{A}_{1}} {\underbrace{\{ {I}_{12} , {I}_{22} \}}}_{{A}_{2}} )$$

In the similar manner, the values of clustering indices for all of the at least one clustering model may be determined and concatenated in the vector I_{T}.

$${I}_{T} = ( {\underbrace{\{ {I}_{11} , {I}_{21} , {I}_{31} , {I}_{n 1} \}}}_{{A}_{1}} , {\underbrace{\{ {I}_{12} , {I}_{22} , {I}_{32} , {I}_{n 2} \}}}_{{A}_{2}} , {\underbrace{\{ {I}_{13} , {I}_{23} , {I}_{33} , {I}_{n 3} \}}}_{{A}_{3}} , … , {\underbrace{\{ {I}_{1 m} , {I}_{2 m} , {I}_{3 m} , {I}_{n m} \}}}_{{A}_{m}} ) \qquad ( 6 )$$

The output of the first step 316 is the multidimensional vector I_{T}.

In a second step 318 of the dataset construction phase 308, the at least one second processor 230 may generate a classification performance score for each of the plurality of classification models C={C₁, C₂, C₃, . . . , Cₙ} for the at least one training sub-datasets. The classification performance score of a classification model for a dataset may indicate a maximum achievable classification performance of the classification model measured as the model-fitness score. The classification performance may be measured using F1 score. F1 score is a weighted average of precision and recall. The value of F1 score may lie between 0-1 (1 being best score and 0 being worst score). The classification performance of different classification models may be collectively represented as vector OT.

$${O}_{T} = \{ {O}_{1} , {O}_{2} , {O}_{3} , … , {O}_{n} \} \qquad ( 7 )$$

In one non-limiting embodiment of the present disclosure, the at least one second processor 230 may generate a best classification performance score for each of the plurality of classification models by tuning one or more hyper parameters corresponding to the plurality of classification models. In one non-limiting embodiment, each classification model may have its own hyperparameters. For example, the classification model ‘Logistic Regression’ may have Penalty and Tolerance as its hyperparameters. Some exemplary classification models and their hyperparameters are listed below in Table 1.

TABLE 1

| Classification Model | Hyperparameter(s) |
|---|---|
| Logistic Regression | Penalty, Tolerance |
| Decision Tree | Max_depth, Split_criterion |
| Random forest | Number_of_trees, Max_depth |
| Support vector machine | Kernel, Gamma |
| K nearest neighbours | Number_of_neighbours |
| XGBoost | Learning_rate, Number_of_estimators |

Now the generation of the vector OT is explained by way of an example. Consider that there are two classification models C₁ and C₂ and there are three training sub-datasets B₁, B₂, and B₃ in the set of training sub-datasets B_{T}.

$$Classification models C = \{ {C}_{1} , {C}_{2} \}$$

$$Training sub - datasets {B}_{T} \{ {B}_{1} , {B}_{2} , {B}_{3} ]$$

Consider that Oᵢⱼ represents classification performance score of classification model Cᵢ for sub-dataset Bⱼ.
Classification performance score of C₁ for sub-dataset B₁=O₁₁
Classification performance score of C₁ for sub-dataset B₂=O₁₂
Classification performance score of C₁ for sub-dataset B₃=O₁₃
Classification performance score of C₂ for sub-dataset B₁=O₂₁
Classification performance score of C₂ for sub-dataset B₂=O₂₂
Classification performance score of C₂ for sub-dataset B₃=O₂₃

In one non-limiting embodiment, the classification performance score of the classification model C₁ for the entire dataset B_{T} may be represented as O₁ and classification performance score of classification model C₁ for the entire dataset B_{T} may be represented as O₂. Now, to determine the classification performance score O₁, the at least one second processor 230 may take average of the classification performance scores O₁₁, O₁₂, O₁₃. i.e.,

Similarly,

$${O}_{1} = avg ( {O}_{11} , {O}_{12} , {O}_{13} )$$

$${O}_{2} = avg ( {O}_{21} , {O}_{22} , {O}_{23} )$$

Now the multi-dimensional vector O_{T} for the classification models Cᵢ and C₂ may be represented as:

$${O}_{T} = \{ {O}_{1} , {O}_{2} \} .$$

The multi-dimensional vector O_{T} for the plurality of classification models C may be represented as:

$${O}_{T} = \{ {O}_{1} , {O}_{2} , {O}_{3} , … , {O}_{n} \} .$$

The output of the second step 318 is the multidimensional vector O_{T}.

In one non-limiting embodiment of the present disclosure, mapper phase 310 may receive two different vectors/datasets from the dataset construction phase 308 i.e., one vector I_{T} of cluster indices and another vector O_{T} of classification performance scores. It may be worth noting here that there is a strong correlation between clustering indices of a dataset under a specific clustering assumption and its maximum achievable classification performance score measured in terms of F1 score for different classification models. This correlation may be modeled as one or more regression functions (or regressors) for the plurality of classification models. In general, regression is a machine learning technique which helps in predicting a continuous outcome variable (y) based on values of one or multiple predictor variables (x). Briefly, the goal of regression function is to build a mathematical equation that defines (y) as a function of the (x) variables. The one or more regression functions may be collectively represented as R:

$$R = \{ {R}_{1} , {R}_{2} , {R}_{3} , … , {R}_{n} \} \qquad ( 8 )$$

In the present disclosure, the regression function may also be referred as mapping function. The goal of the mapper phase 310 is to build a trained model 320 using one or more mapping/regression functions.

In one non-limiting embodiment of the present disclosure, the at least one second processor 230 may train the one or more regression functions R using the vectors (I_{T}, O_{T}) as training data.

$$R : {I}_{T} \to {O}_{T} \qquad ( 9 )$$

The at least one second processor 230 may evaluate the performance of a regression function using R-squared (R2) metric. R-squared is a statistical measure that represents the proportion of the variance for a dependent variable that's explained by an independent variable or variables in a regression function. One or more hyper-parameters of the regressor function R may be tuned using cross-validation on the training sub-datasets. In this manner a regression function which gives best performance on the at least one second dataset may be selected. In one non-limiting embodiment, the at least one second processor 230 may build individual regression functions for the plurality of classification models instead of a single regression function for all classification models. The best performing regression function(s) constitute the trained model or the prebuilt model 320. The training phase 302 is over once the trained model 320 is generated.

In one non-limiting embodiment of the present invention, if each dataset of the at least one second dataset 170 is considered as a single instance vector of clustering indices, the number of training samples gets limited by the numbers of the dataset present in the at least one second dataset 170. Hence, it becomes hard to train the regressor function due to the shortage of training samples. Thus, the regression functions are trained using the sub-datasets instead of the full dataset. In this process, every dataset undergoes augmentation by random sampling with replacement to generate a plurality of training sub-datasets. An advantage of using sub-datasets instead of the full datasets is more variability in the datasets used for training the regression functions, making the regression functions robust against the dataset variance. Another advantage is that it is easy to generate clustering indices from the sub-datasets compared to working with large datasets in a single shot.

### Prediction Phase:

In one non-limiting embodiment of the present disclosure, the trained/pre-built model 320 may be utilized in the prediction phase 304 for prediction class labels or recommending classification models for at least one first dataset 160. In the recommendation phase 312, the at least one second processor 230 may receive the at least one first dataset 160. The at least one first dataset 160 may be collectively represented as D_{P} and may comprise one or more datasets.

$${D}_{P} = \{ {D}_{1}^{′} , {D}_{2}^{′} , {D}_{3}^{′} , … , {D}_{n}^{′} \} \qquad ( 10 )$$

The at least one first dataset 160 may comprise at least one labeled dataset and at least one unlabeled dataset. The at least one labeled dataset may be used for building/training one or more classification models. The at least one second processor 230 may use the built classification models for classifying the at least one unlabeled dataset.

In one non-limiting embodiment of the present disclosure, in block 322, the at least one second processor 230 may process the received at least one labeled dataset to generate at least one first meta feature from the at least one labeled dataset. In the present disclosure, the meta features are cluster indices. Initially, the at least one second processor 230 may preprocess the received at least one labeled dataset to generate at least one cleaned dataset. Then the at least one second processor 230 may generate one or more sub-datasets from the at least one cleaned dataset. The one or more sub-datasets may be represented as

$${B}_{P} = \{ {B}_{1}^{′} , {B}_{2}^{′} , {B}_{3}^{′} , … , {B}_{n}^{′} \} \qquad ( 11 )$$

In one non-limiting embodiment of the present disclosure, the at least one second processor 230 may process the at least one cleaned dataset using at least one clustering model to generate at least one first cluster. The at least one cluster generated in the training phase 302 may be referred as at least one second cluster. The at least one second processor 230 may then process the at least one first cluster to generate a multi-dimensional vector comprising at least one first cluster index. It may be worth noting here that the detailed explanation of the data cleaning, sub-dataset generations, cluster index generation has already been described while explaining the training phase 302. Thus, the same has been omitted here for the sake of brevity. The at least one first cluster index may be collectively represented as a multi-dimensional vector I_{P} and may comprise one or more cluster indices for each of the at least one clustering model similar to equation (6). Now the aim of the recommendation phase 312 is to find classification performance scores of each of the plurality of classification models for the at least one labeled dataset.

In one non-limiting embodiment of the present disclosure, the at least one second processor 230 may query the pre-built model 320 using the at least one first cluster index. Particularly, the at least one second processor 230 may correlate the at least one first cluster index with the pre-built model 320 that comprises a plurality of classification models. As describes above, the prebuilt model 320 may comprise at least one best mapping function R for mapping at least one meta feature with a plurality of classification performance scores corresponding to the plurality of classification models. The at least one second processor 230 may estimate/predict a classification performance score of each of the plurality of classification models for the at least one labeled dataset, based on correlating the at least one first cluster index with the prebuilt model 320.

In one non-limiting embodiment of the present disclosure, the multi-dimensional vector I_{P} comprising the at least one first cluster index may be input to the at least one mapping function R of the prebuilt model 320 to make an estimation of an expected classification performance score or model-fitness score of each of the plurality of classification models C. The estimated classification performance score 324 for a particular classification model for the at least one labelled dataset may be obtained by averaging the estimated classification performance scores 324 of the particular classification model for each dataset of the sub-dataset B_{P}. The estimated classification performance scores 324 may be collectively represented as O_{P} and calculated as:

$${O}_{P} ← R ( {I}_{P} ) and \qquad ( 12 )$$

$${O}_{P} = \{ {O}_{1}^{′} , {O}_{2}^{′} , {O}_{3}^{′} , … , {O}_{n}^{′} \} \qquad ( 13 )$$

Thus, using the techniques described in the present disclosure, the classification performance scores for different classification models can be predicted without even training them over the at least one first dataset 160. This prediction is based on clustering indices extracted from the at least one first dataset 160.

In one non-limiting embodiment of the present disclosure, after estimating the classification performance scores of each of the plurality of classification models for the at least one labeled dataset, the at least one second processor 230 may generating an ordered list of the plurality of classification models. The ordered list may comprise the plurality of classification models arranged in descending order of the estimated classification performance scores 324 (i.e., the classification model having highest classification performance score is placed at top of the list and the classification model having lowest classification performance score is placed at the bottom of the list). Thus, using the techniques of the present disclosure, a best classification model may be recommended for the at least one first dataset based on the estimated classification performance scores 324.

In one non-limiting embodiment of the present disclosure, the at least one second processor 230 may select a predefined number (N) of top classification models from the ordered list for building an ensemble classification model 326. In the model building/classification phase 314, the at least one second processor 230 may use the at least one labeled dataset to build/train only the TOP_{N} classification models with the best parameter settings.

The at least one second processor 230 may then receive the at least one unlabeled dataset. The at least one second processor 230 may use the ensemble classification model 326 to classify the at least one unlabeled dataset or to predict class labels for the at least one unlabeled dataset. For predicting the class labels, the at least one second processor 230 may generate predictions of class labels using the TOP_{N} classification models and may combine their outputs using any one of: majority voting, weighted averaging, and model stacking for predicting the class labels for the at least one unlabeled dataset.

Thus, the present disclosure describes techniques that use clustering indices as meta-features for automatically selecting and recommending one or more classification models from a plurality of classification models. The disclosed techniques of data classification and model selection are time efficient and require less computing resources. The disclosed techniques have a higher accuracy compared to other techniques of data classification.

In one non-limiting embodiment of the present disclosure, hyper parameters control the behavior of the computing system 120. The hyper parameters may be tuned by trial and error. Examples of the hyper parameters may be: a number of clusters and a number of training sub-datasets. The number of clusters is a critical parameter for most clustering models. The number of clusters may be set to a value which gives best results. Similarly, the number of training sub-samples may be set to a value which gives best results.

In one non-limiting embodiment of the present disclosure, the at least one second processor 230 may determine a classification complexity of the at least one first dataset 160. The classification-complexity may denote the difficulty of learning a classification model on a given dataset. The at least one second processor 230 may compare the estimated classification performance scores O_{P} with a predefined threshold value. If the value of any estimated classification performance score is less than the predefined threshold value then the classification complexity is higher and the at least one first dataset 160 is difficult/hard to learn. On the other hand, if the values of all of the estimated classification performance scores are higher than or equal to the predefined threshold value then the classification complexity is low and the at least one first dataset 160 is easy to learn. It may be noted here that the value of the predefined threshold may be based on trial and error.

Thus, the present disclosure may estimate the classification complexity of the at least one first dataset with respect to a model class prior to the classification model selection, it becomes relatively straightforward to pick a suitable classification model to solve a classification problem. This is particularly useful while working with large datasets, as it is laborious and time-consuming to evaluate different classification models with a large population for classification model selection.

In one non-limiting embodiment of the present disclosure, the proposed automatic model classification techniques may be extended to an Automatic Machine Learning platform for offering classification modeling as a service. Particularly, the techniques of the present disclosure may provide machine learning as a service platform where clustering indices may be used as data characteristics for classification model selection and build sophisticated machine learning models. A functional and ready-to-use Machine Learning as a Service (MLaaS) platform is beneficial for organizations, developers, and researchers to examine the learning curve of how this paradigm works and helps in building their solutions. It saves them from the cost of high computational and human resources.

The MLaaS platform may be provided to users in the form application programming interface (API) or deployable solutions. The clients may upload the at least one first dataset and the platform may provide class labels or recommended model(s) for classification to the clients. This saves additional computational costs and enhances their user experience.

Thus, the techniques of the present disclosure can do a faster classification of data and may provide more accurate class labels in real time (even for huge datasets).

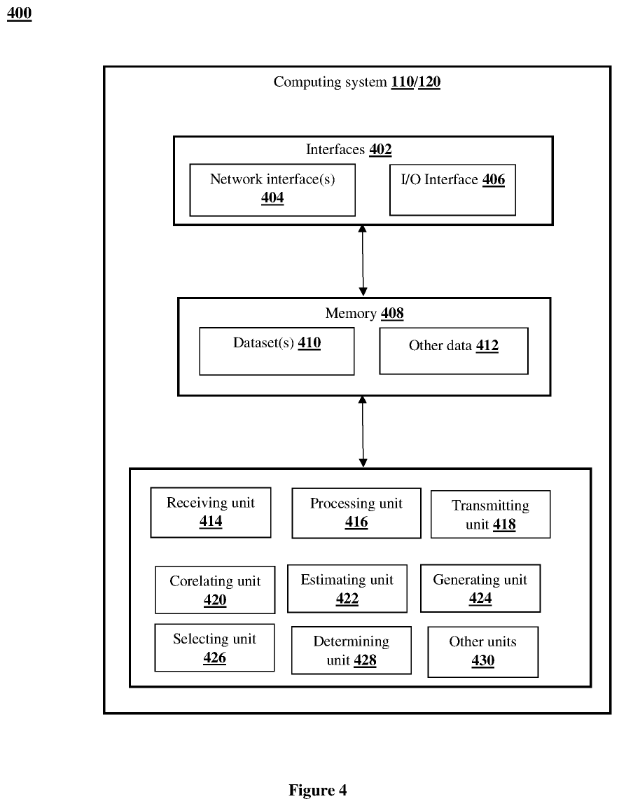

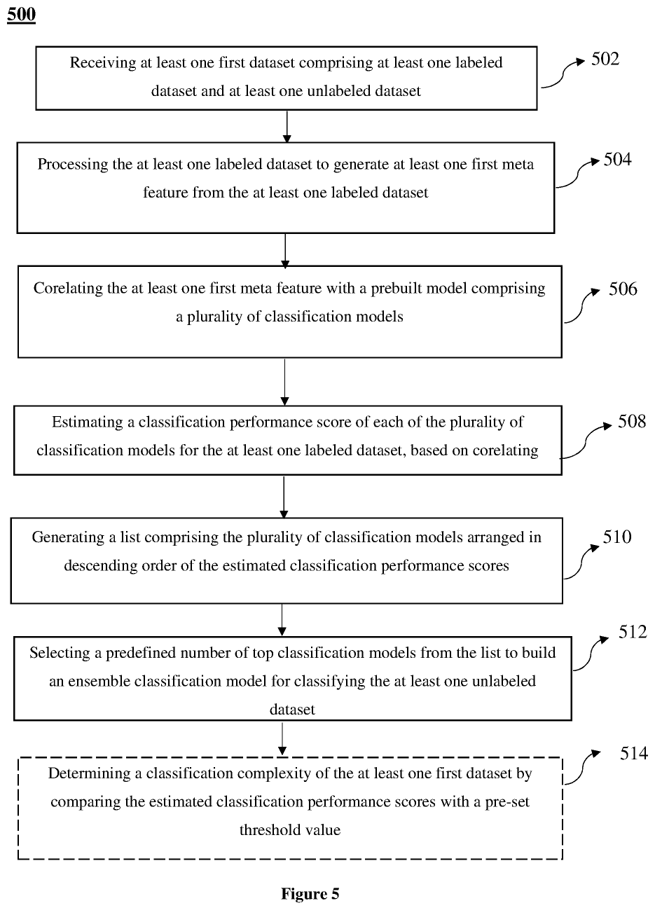

Referring now to FIG. 4, which shows a block diagram of a computing system 110, 120, in accordance with some embodiments of the present disclosure. In one non-limiting embodiment of the present disclosure, the computing systems 110, 120 may comprise various other hardware components such as various interfaces 402, memory 408. and various units or means as shown in FIG. 4. The units may comprise a receiving unit 414, a processing unit 416, a transmitting unit 418, and a correlating unit 420, an estimating unit 422, a generating unit 424, a selecting unit 426, a determining unit 428, and various other units 430. The other units 430 may comprise a display unit, an identifying unit, a mapping unit etc. In an embodiment, the units 414-430 may be dedicated hardware units capable of executing one or more instructions stored in the memory 408 for performing various operations of the computing system 110, 120. In another embodiment, the units 414-430 may be software modules stored in the memory 408 which may be executed by the at least one processor 210, 230 for performing the operations of the computing system 110, 120.

The interfaces 402 may include a variety of software and hardware interfaces, for example, a web interface, a graphical user interface, an input device-output device (I/O) interface 406, a network interface 404 and the like. The I/O interfaces 406 may allow the computing system 110, 120 to interact with other computing systems directly or through other devices. The network interface 404 may allow the computing system 110, 120 to interact with one or more data sources 130, 140 either directly or via the network 150.

The memory 408 may comprise one or more datasets 410, and other various types of data 412 (such as one or more cleaned datasets, one or more cluster indices, one or more clustering models, one or more classification models, one or more classification performance scores, one or more datasets of training and testing etc.). The memory 408 may further store one or more instructions executable by the at least processor 210, 230. The memory 408 may be any of the memories 240, 260.

Referring now to FIG. 5, a flowchart is described illustrating an exemplary method 500 for data classification, according to an embodiment of the present disclosure. The method 500 is merely provided for exemplary purposes, and embodiments are intended to include or otherwise cover any methods or procedures for generating at least one pattern from at least one data set.

The method 500 may include, at block 502, receiving the at least one first dataset. The at least one first dataset may comprise at least one labeled dataset and at least one unlabeled dataset and may be received by the at least one second processor 230 from the at least one first processor 210. The operations of block 502 may be performed by the at least one second processor 230 of FIG. 2 or by the receiving units 414 of FIG. 4.

At block 504, the method 500 may include processing the at least one labeled dataset to generate at least one first meta feature from the at least one labeled dataset. The at least one first meta feature may be at least one first cluster index. For example, the at least one second processor 230 may be configured to process the at least one labeled dataset to generate at least one first meta feature from the at least one labeled dataset. The operations of block 504 may also be performed by the processing unit 416 of FIG. 4.

In one non-limiting embodiment of the present disclosure, the operation of block 504 i.e., processing the at least one labeled dataset to generate at least one first meta feature may comprise processing the at least one labeled dataset to generate at least one cleaned dataset and processing the at least one cleaned dataset using at least one clustering model to generate one or more clusters. For example, the at least one second processor 230 of FIG. 2 or the processing unit 416 of FIG. 4 may be configured to process the at least one labeled dataset to generate at least one cleaned dataset and process the at least one cleaned dataset using at least one clustering model to generate one or more clusters.

In one non-limiting embodiment of the present disclosure, the operation of block 504 i.e., processing the at least one labeled dataset to generate at least one first meta feature may further comprise generating a multi-dimensional vector by processing the one or more clusters. For example, the at least one second processor 230 of FIG. 2 or the generating unit 424 of FIG. 4 may be configured to generate a multi-dimensional vector by processing the one or more clusters. The multi-dimensional vector may comprise the at least one first meta feature.

At block 506, the method 500 may include correlating the at least one first meta feature with a prebuilt model. For example, the at least one second processor 230 of FIG. 2 or the correlating unit 420 of FIG. 4 may be configured to correlate the at least one first meta feature with a prebuilt model. The prebuilt model may comprise a plurality of classification models. The prebuilt model may further comprise at least one mapping function for mapping at least one pre-calculated meta feature with a plurality of pre-calculated classification performance scores corresponding to the plurality of classification models.

At block 508, the method 500 may include estimating a classification performance score of each of the plurality of classification models for the at least one labeled dataset, based on correlating the at least one first meta feature with the prebuilt model. For example, the at least one second processor 230 of FIG. 2 or the estimating unit 422 of FIG. 4 may be configured to estimate a classification performance score of each of the plurality of classification models for the at least one labeled dataset, based on correlating the at least one first meta feature with the prebuilt model.

At block 510, the method 500 may include generating a list comprising the plurality of classification models arranged in descending order of the estimated classification performance scores. For example, the at least one second processor 230 of FIG. 2 or the generating unit 424 of FIG. 4 may be configured to generate a list comprising the plurality of classification models arranged in descending order of the estimated classification performance scores.

At block 512, the method 500 may include selecting a predefined number of top classification models from the list to build an ensemble classification model for classifying the at least one unlabeled dataset. For example, the at least one second processor 230 of FIG. 2 or the selecting unit 426 of FIG. 4 may be configured to select a predefined number of top classification models from the list to build an ensemble classification model for classifying the at least one unlabeled dataset.

In one non-limiting embodiment of the present disclosure, classifying the at least one unlabeled dataset may comprise processing the at least one unlabeled dataset using the ensemble classification model to predict class labels based on one of: majority voting, weighted averaging, and model stacking. For example the at least one second processor 230 of FIG. 2 or the processing unit 416 of FIG. 4 may be configured to process the at least one unlabeled dataset using the ensemble classification model to predict class labels based on one of: majority voting, weighted averaging, and model stacking.

At block 514, the method 500 may include determining a classification complexity of the at least one first dataset by comparing the estimated classification performance scores with a preset threshold value. For example, the at least one second processor 230 of FIG. 2 or the determining unit 428 of FIG. 4 may be configured to determine a classification complexity of the at least one first dataset by comparing the estimated classification performance scores with a preset threshold value.

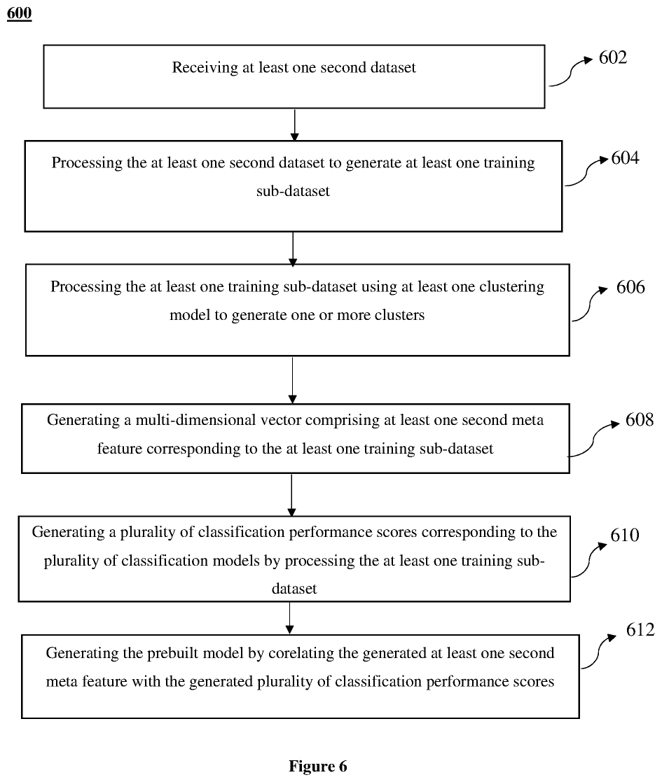

Referring now to FIG. 6, a flowchart is described illustrating an exemplary method 600 for generating the prebuilt model 320, according to an embodiment of the present disclosure. The method 600 is merely provided for exemplary purposes, and embodiments are intended to include or otherwise cover any methods or procedures for generating at least one pattern from at least one data set.

The method 600 may include, at block 602, receiving or extracting at least one second dataset. The at least one second dataset may be received by the at least one second processor 230 from the at least one first processor 210. The operations of block 602 may be performed by the at least one second processor 230 of FIG. 2 or by the receiving unit 414 of FIG. 4.

At block 604, the method 600 may include processing the at least one second dataset to generate at least one training sub-dataset. For example, the at least one second processor 230 of FIG. 2 or the processing unit 416 of FIG. 4 may be configured to process the at least one second dataset to generate at least one training sub-dataset.

At block 606, the method 600 may include processing the at least one training sub-dataset using at least one clustering model to generate one or more clusters. For example, the at least one second processor 230 of FIG. 2 or the processing unit 416 of FIG. 4 may be configured to process the at least one training sub-dataset using at least one clustering model to generate one or more clusters.

At block 608, the method 600 may include generating a multi-dimensional vector by processing the one or more clusters. For example, the at least one second processor 230 of FIG. 2 or the generating unit 424 of FIG. 4 may be configured to generate a multi-dimensional vector by processing the one or more clusters. The multi-dimensional vector comprises at least one second meta feature corresponding to the at least one training sub-dataset. The at least one second meta feature may be at least one second cluster index.

At block 610, the method 600 may include generating a plurality of classification performance scores corresponding to the plurality of classification models by processing the at least one training sub-dataset. For example, the at least one second processor 230 of FIG. 2 or the generating unit 424 of FIG. 4 may be configured to generate a plurality of classification performance scores corresponding to the plurality of classification models by processing the at least one training sub-dataset.

In one non-limiting embodiment of the present disclosure, the operation of block 610 i.e., generating a plurality of classification performance scores corresponding to the plurality of classification models may comprise generating a best classification performance score for each of the plurality of classification models by tuning one or more hyper parameters corresponding to the plurality of classification models. For example, the at least one second processor 230 of FIG. 2 or the generating unit 424 of FIG. 4 may be configured to generate a best classification performance score for each of the plurality of classification models by tuning one or more hyper parameters corresponding to the plurality of classification models.

At block 612, the method 600 may include generating the prebuilt model by correlating the generated at least one second meta feature with the generated plurality of classification performance scores. For example, the at least one second processor 230 of FIG. 2 or the generating unit 424 of FIG. 4 may be configured to generate the prebuilt model by correlating the generated at least one second meta feature with the generated plurality of classification performance scores. The at least one second meta feature may correspond to the at least one pre-calculated meta feature, and the plurality of classification performance scores may correspond to the plurality of pre-calculated classification performance scores.

The above methods 500, 600 may be described in the general context of computer executable instructions. Generally, computer executable instructions can include routines, programs, objects, components, data structures, procedures, modules, and functions, which perform specific functions or implement specific abstract data types.

The order in which the various operations of the methods are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. The means may include various hardware and/or software component(s) and/or module(s), including, but not limited to the processors 210, 230 of FIG. 2 and the various units of FIG. 4. Generally, where there are operations illustrated in Figures, those operations may have corresponding counterpart means-plus-function components.

It may be noted here that the subject matter of some or all embodiments described with reference to FIGS. 1-4 may be relevant for the method and the same is not repeated for the sake of brevity.

In a non-limiting embodiment of the present disclosure, one or more non-transitory computer-readable media may be utilized for implementing the embodiments consistent with the present disclosure. Certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

The terms “including”, “comprising”, “having” and variations thereof mean “including but not limited to”, unless expressly specified otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the appended claims.

We claim:

1. A method (500) for data classification, comprising:
receiving (502) at least one first dataset, wherein the at least one first dataset comprises at least one labeled dataset and at least one unlabeled dataset;
processing (504) the at least one labeled dataset to generate at least one first meta feature from the at least one labeled dataset, wherein the at least one first meta feature is at least one first cluster index;
correlating (506) the at least one first meta feature with a prebuilt model (320) comprising a plurality of classification models, wherein the prebuilt model (320) further comprises at least one mapping function for mapping at least one pre-calculated meta feature with a plurality of pre-calculated classification performance scores corresponding to the plurality of classification models;
estimating (508) a classification performance score of each of the plurality of classification models for the at least one labeled dataset, based on correlating the at least one first meta feature with the prebuilt model (320);
generating (510) a list comprising the plurality of classification models arranged in descending order of the estimated classification performance scores; and
selecting (512) a predefined number of top classification models from the list to build an ensemble classification model for classifying the at least one unlabeled dataset.

2. The method as claimed in claim 1, wherein classifying the at least one unlabeled dataset comprises:
processing the at least one unlabeled dataset using the ensemble classification model to predict class labels based on one of: majority voting, weighted averaging, and model stacking.

3. The method as claimed in claim 1, wherein processing the at least one labeled dataset to generate at least one first meta feature comprises:
processing the at least one labeled dataset to generate at least one cleaned dataset;
processing the at least one cleaned dataset using at least one clustering model to generate one or more clusters; and
generating a multi-dimensional vector by processing the one or more clusters, the multi-dimensional vector comprising the at least one first meta feature.

4. The method as claimed in claim 1, further comprising:
determining a classification complexity of the at least one first dataset by comparing the estimated classification performance scores with a preset threshold value.

5. The method as claimed in claim 1, wherein the prebuilt model is generated by:
receiving at least one second dataset;
processing the at least one second dataset to generate at least one training sub-dataset;
processing the at least one training sub-dataset using at least one clustering model to generate one or more clusters;
generating a multi-dimensional vector by processing the one or more clusters, wherein the multi-dimensional vector comprises at least one second meta feature corresponding to the at least one training sub-dataset, wherein the at least one second meta feature is at least one second cluster index;
generating a plurality of classification performance scores corresponding to the plurality of classification models by processing the at least one training sub-dataset; and
generating the prebuilt model by correlating the generated at least one second meta feature with the generated plurality of classification performance scores, wherein the at least one second meta feature corresponds to the at least one pre-calculated meta feature, and wherein the plurality of classification performance scores corresponds to the plurality of pre-calculated classification performance scores.

6. The method as claimed in claim 5, wherein generating a plurality of classification performance scores corresponding to the plurality of classification models comprises generating a best classification performance score for each of the plurality of classification models by tuning one or more hyper parameters corresponding to the plurality of classification models.

7. A system (120) for data classification, comprising:
a memory (240); and
at least one processor (230) communicatively coupled with the memory (240), wherein the at least one processor (230) is configured to:
receive at least one first dataset, wherein the at least one first dataset comprises at least one labeled dataset and at least one unlabeled dataset;
process the at least one labeled dataset to generate at least one first meta feature from the at least one labeled dataset, wherein the at least one first meta feature is at least first one cluster index;
correlate the at least one first meta feature with a prebuilt model (320) comprising a plurality of classification models, wherein the prebuilt model (320) further comprises at least one mapping function for mapping at least one pre-calculated meta feature with a plurality of pre-calculated classification performance scores corresponding to the plurality of classification models;
estimate a classification performance score of each of the plurality of classification models for the at least one labeled dataset, based on correlating the at least one first meta feature with the prebuilt model (320);
generate a list comprising the plurality of classification models arranged in descending order of the estimated classification performance scores; and
select a predefined number of top classification models from the list to build an ensemble classification model for classifying the at least one unlabeled dataset.

8. The system as claimed in claim 7, wherein the at least one processor is configured to classify the at least one unlabeled dataset by:
processing the at least one unlabeled dataset using the ensemble classification model to predict class labels based on one of: majority voting, weighted averaging, and model stacking.

9. The system as claimed in claim 7, wherein the at least one processor is configured to process the at least one labeled dataset to generate at least one first meta feature by:
processing the at least one labeled dataset to generate at least one cleaned dataset;
processing the at least one cleaned dataset using at least one clustering model to generate one or more clusters; and
generating a multi-dimensional vector by processing the one or more clusters, the multi-dimensional vector comprising the at least one first meta feature.

10. The system as claimed in claim 7, wherein the at least one processor is further configured to:
determine a classification complexity of the at least one first dataset by comparing the estimated classification performance scores with a preset threshold value.

11. The system as claimed in claim 7, wherein the at least one processor is further configured to generate the prebuilt model by:
receiving at least one second dataset;
processing the at least one second dataset to generate at least one training sub-dataset;
processing the at least one training sub-dataset using at least one clustering model to generate one or more clusters;
generating a multi-dimensional vector by processing the one or more clusters, wherein the multi-dimensional vector comprises at least one second meta feature corresponding to the at least one training sub-dataset, wherein the at least one second meta feature is at least one second cluster index;
generating a plurality of classification performance scores corresponding to the plurality of classification models by processing the at least one training sub-dataset; and
generating the prebuilt model by correlating the generated at least one second meta feature with the generated plurality of classification performance scores, wherein the at least one second meta feature corresponds to the at least one pre-calculated meta feature, and wherein the plurality of classification performance scores corresponds to the plurality of pre-calculated classification performance scores.

12. The system as claimed in claim 11, wherein the at least one processor is configured to generate a plurality of classification performance scores corresponding to the plurality of classification models by generating a best classification performance score for each of the plurality of classification models by tuning one or more hyper parameters corresponding to the plurality of classification models.

13. The system as claimed in claim 7, wherein the system is configured to provide a Machine Learning as a service (MLaaS) platform for data classification and classification model selection.
